(19) United States
(12) Patent Application Publication
(10) Pub. No.: US 2006/0242087 A1
(43) Pub. Date: Oct. 26, 2006

(54) Point-of-sale and declining balance system, and method, having a relay server for facilitating communication between front-end devices and back-end account servers

(76) Inventors: Gregory Naehr, Drexel Hill, PA (US); Richard Robert Wysocki, Abington, PA (US); Mark Freeman, Houston, TX (US)

Correspondence Address: COZEN O'CONNOR, P.C., 1900 MARKET STREET, PHILADELPHIA, PA, 19103-3508, US

(21) Appl. No.: 11/112,987

(22) Filed: Apr. 22, 2005

(51) Int. Cl. G06Q 99/00

(52) U.S. Cl. 705/68

(57) ABSTRACT

A point-of-sale and declining balance (“POS/DB”) system, and method of facilitating transactions thereon, that utilizes a relay server to facilitate communication between front-end devices and back-end devices that use different data formats. The relay server acts as a translator between the front-end device and the back-end account servers. In one embodiment, a standardized data format for front-end device is introduced that, when coupled with the relay server, isolates the front-end devices from the complexities of various back-end account servers. In one aspect, the invention is the relay server itself.

### FIELD OF THE INVENTION

The present invention relates generally to the field of point-of-sale and declining balance (“POS/DB”) systems and methods, and specifically to POS/DB systems used in a campus environment for cashless transactions.

### BACKGROUND OF THE INVENTION

In recent years, POS/DB systems have become common place in campus environments such as colleges and universities. Campus POS/DB systems afford users the means by which to carry out cashless commercial transactions. For example, one traditional use of such campus POS/DB systems is in campus dining establishments. In this environment, an account is first purchased by the user. The account information, including monetary value, identification number, approved uses, etc. is stored on a back-end account server. The back-end account servers can store the account information for a multitude of users simultaneously.

An identification device, such as a smart card, magnetic strip card, pin code, or the like, that is associated with (i.e., linked to) the user account is issued to the user. When the user desires to perform a commercial transaction, such as purchase a meal at a campus dining establishment, the user presents the identification device to a front-end POS transaction device, such as a card reader, to provide verification and identification to the back-end account server. The back-end account server is connected to the front-end POS transaction device via a network.

Upon being presented to the front-end POS transaction device, the card accepting device sends a request to the back-end server. The request will typically have a monetary or other unit value associated with it. The back-end server receives and processes the request, checking the stored information of the account linked to the identification device to ensure adequate funds, and updating the account information if necessary (e.g. decreasing the balance of the account). The account server transmits an appropriate response to the front-end POS transaction device either approving, denying, or otherwise carrying out the request.

As the popularity of POS/DB systems has increased over the years, so has their functionality, versatility, and field of use. An increasing number of consumer devices and transactions have been adapted to be compatible with POS/DB systems. As with any business, as the consumer demand for POS/DB systems has grown, so has the number of companies that supply the necessary hardware and software applications, including both front-end POS transaction devices and back-end account servers.

However, the various companies that supply the hardware for POS/DB system use a variety of protocols, standards, and/or data formats for hardware communication, data transfer, networking, and data processing. As a result, it is common for the hardware supplied by one company to be incompatible with the hardware supplied by another company. As such, compatibility issues consistently arise and force a customer to commit to a single vendor for all of their POS/DB system hardware. For obvious reasons, such as lack of selection, lack of competition, and the possibility of inferior product, this is undesirable.

One major problem that arises from being forced to purchase all POS/DB system hardware from a single vendor is that a customer can be forced to purchase front-end hardware at an inflated cost. The back-end hardware of POS/DB systems, such as the account server, are very expensive in comparison to the front-end hardware. When an entity establishes a POS/DB system on campus, the back-end hardware constitutes a substantial sunken cost. Thus, once an entity has purchased and set up a POS/DB system, it is unlikely to undertake the costs associated with replacing the back-end hardware, even if the entity is unhappy with the prices associated with that supplier's front-end hardware. Therefore, once a supplier has set up the POS/DB system for a campus entity, including the back-end hardware, some suppliers will use this leverage to charge higher prices for the front-end hardware, thereby inhibiting the entities expansion of their POS/DB system.

### SUMMARY OF THE INVENTION

It is therefore an object of the present invention to provide a POS/DB system and method.

Another object of the present invention is to provide a POS/DB system and method that facilitates communication between hardware devices of a POS/DB system that use different data formats and/or protocols for communication, data transfer, networking, and data processing.

Yet another object of the present invention is to provide a POS/DB system and method that facilitates communication between front-end devices and back-end devices that use different data formats and/or protocols for communication, data transfer, networking, and data processing.

Still another object of the present invention is to provide a POS/DB system and method that affords POS/DB system owners the freedom to incorporate front-end hardware from any manufacture into their existing POS/DB system without changing the account server or other back-end hardware.

A further object of the present invention is to provide a relay server for use in a POS/DB system that performs a data conversion/translation function to facilitate communication between hardware that utilize different data formats and/or protocols for communication, data transfer, networking, and data processing.

A yet further object of the present invention is to provide a POS/DB system and method that encourages industry acceptance of a data format standard for front-end devices.

These and other objects are met by the present invention which is a relay server for use in a POS/DB system that is programmed to convert/translate data signals having a first data format into data signals having a second data format. By positioning the relay server in the POS/DB system at a position between front-end devices (e.g., a transactions device) and back-end servers (e.g. the account server), the relay server can facilitate communication between the front-end devices and the back-end server despite the front-end device communicating in the first data format and the back-end server communicating in the second data format.

In one embodiment, the invention can be a point-of-sale and declining balance (“POS/DB”) system for use in a campus environment comprising: a campus network comprising at least one transaction device that communicates in a first data format, a relay server operably connected to the transaction device, and an account server operably connected to the relay server that communicates in a second data format, the account server comprising a computer memory medium storing account information; and wherein the relay server comprises means for converting data signals in the first data format into corresponding data signals in the second data format, and vice versa, to facilitate communication between the transaction device and the account server.

In some embodiments, the campus network may be part of an educational institution, correctional facility, entertainment facility, sports facility, business, hospital, healthcare system, or research institute. The transaction device can be almost any type of device, including without limitation, a cash register, a vending machine, a laundry machine, or a website.

In some embodiments, the first data format can be extensible markup language (“XML”) or a modified XML format based on standards established by the Association for Retail Technology Standards (“ARTS”).

In one embodiment, the campus network can be a local area network (“LAN”). In anther embodiment, the data signals (in the first data format) can be transmitted between the relay server and the transaction device via web services. In embodiments where web services are used to transmit the data signals between the relay server and the transaction device, the web services preferably utilize a port 80 standard.

The relay server can be a stand-alone server in some embodiments, and may sit on or near the account management server. In order to maintain security, the relay server will be located behind the campus network's firewall in some embodiments of the invention. Security can be further provided by programming the campus network with the ability to encrypt all data signals transmitted between the transaction device, the relay server, and the account server. One suitable data encryption standard is a triple data encryption standard (“DES”). In embodiments where encryption capabilities are utilized, the campus network will of course further comprise means to decrypt the data at the necessary junctures.

The data signals (in the second data format) can be transmitted between the relay server and the account server via web services or transmission control protocol (“TCP”) sockets. In one embodiment, the relay server can further comprise means to log transactions conducted between the transaction device and the account server. In some embodiments, the campus network may further comprise means to communicate information to an exterior system.

In order to further the universal use of the relay server in POS/DB systems, the relay server, in some embodiments, will be programmed so that it can convert/translate data signals in the first data format into a multitude of data formats. This allows a single relay server to be used with a variety of account servers that communicate using different data formats. Moreover, in some embodiments, this will allow a single POS/DB system to utilize more than one kind of account server simultaneously (i.e., account servers communicating using different data formats). In one such embodiment, the POS/DB system can further comprise a second account server that communicates in a third data format, the relay server further comprising means for converting data signals in the first data format into corresponding data signals in the third data format, and vice versa, to facilitate communication between the transaction device and the second account server.

In some embodiments, the POS/DB system will further comprise an identification device associated with a user account stored on the account server. Suitable identification devices include, without limitation, smart cards, magnetic strip cards, and pin codes. In this embodiment, the transaction device will further comprise means for validating the identification device, means for receiving a user request associated with the user account upon the identification device being validated, and means for converting the user request into a request signal in the first data format upon a user request being received, and means for transmitting the request signal to the relay server. The relay server will further comprise means for receiving the request signal in the first data format from the transaction device, means for converting the request signal to the second data format upon receiving the request signal; and means for transmitting the converted request signal to the account server. The account server will further comprise means for receiving the converted request signal from the relay server, means for processing the converted request signal upon receipt of the converted request signal, means to update the user account information stored on the computer memory medium if necessary, and means to create a response signal in the second data format as a result of the processing of the converted request signal and/or updating of the user account information.

In a still further embodiment of the POS/DB system that utilizes an identification device associated with a user account stored on the account server, the account server may further comprise means for transmitting the response signal to the relay server upon the response signal being created. The relay server may further comprise means for receiving the response signal from the account server, means for converting the response signal to the first data format upon receiving the response signal; and means for transmitting the converted response signal to the transaction device. The transaction device may further comprise means for receiving the response signal from the relay server, and means for executing the response signal.

In one embodiment, the transaction device may further comprise means for updating the associated account information on the identification device if necessary.

In another aspect, the invention can be a point-of-sale and declining balance (“POS/DB”) system for use in a campus environment comprising: an identification device associated with a user account; at least one transaction device for reading said identification device and receiving requests associated with said user account, the transaction device communicating via a first data format; an account server having a computer memory medium storing information pertaining to the user account, the account server communicating via a second data format; and a relay server operably connected to the transaction device and the account manager server, the relay server comprising a converter for converting the first data format into the second data format and vice versa to facilitate communication between the transaction device and the account server. This embodiment of the invention can incorporate any or all of the details discussed above.

In yet another aspect, the invention can be a method of performing a cashless transaction on a point-of-sale (“POS”) and declining balance (“DB”) system in a campus environment comprising: (a) providing a campus system comprising at least one transaction device, the transaction device communicating in a first data format, an account management server storing user account information, the account server communicating via a second data format, and a relay server operably connected to the transaction device and the account server; (b) upon the transaction server receiving a request associated with an account stored on the account server, generating a request signal in the first data format with the transaction device; (c) transmitting the request signal to the relay server; (d) upon the relay server receiving the request signal, converting the request signal to the second data format; (e) transmitting the converted request signal to the account server; (f) upon the account server receiving the converted request signal, processing the converted request signal and, if necessary, updating the account information; (g) the account server generating a response signal in the second data format and transmitting the response signal to the relay server; (h) upon the relay server receiving the response signal, the relay server converting the response signal into the first data format and transmitting the converted response signal to the transaction device; and (i) upon the transaction device receiving the converted response signal, the transaction device either completing or denying the user request.

The method of the invention can incorporate any or all of the aspects, functioning, or steps discussed above with respect to the systems.

### BRIEF DESCRIPTION OF THE DRAWINGS

FIG. 1 is a high level schematic of a POS/DB system according to one embodiment of the present invention.

FIG. 2 is a schematic of the POS/DB system of FIG. 1 according to an embodiment of the present invention.

FIG. 3 a high level flowchart of the decision process undertaken by a transaction device in receiving a transaction request from a user having an account stored on the POS/DB system according to an embodiment of the present invention.

FIG. 4 is a high level flowchart of the decision process undertaken by the relay server in converting a request signal in modified XML format into a different data format used by an account server according to an embodiment of the present invention.

FIG. 5 is a high level flowchart of the decision process undertaken by the account server in processing a converted request signal according to one embodiment of the present invention.

FIG. 6 is a high level flowchart of the decision process undertaken by the relay server in converting a response signal that is in the data format that can be understood by the API of the account server into the modified XML format according to one embodiment of the present invention.

FIG. 7 is a high level flowchart of the decision process undertaken by the transaction device in processing a converted response signal according to an embodiment of the present invention.

### DETAILED DESCRIPTION OF THE DRAWINGS

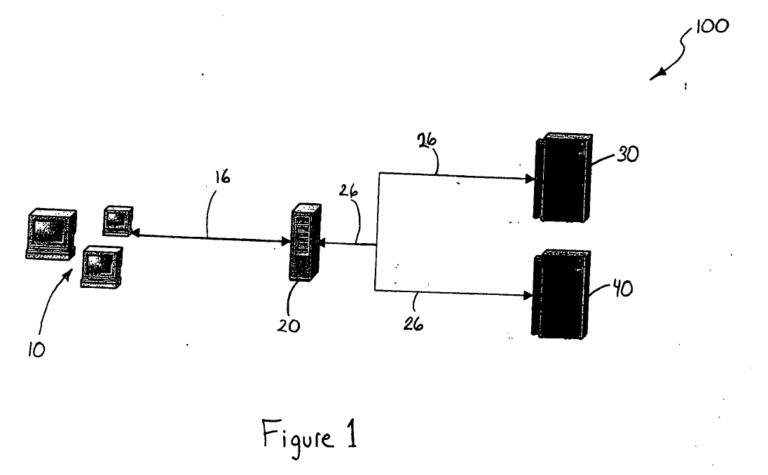

FIG. 1 is a high level schematic of a POS/DB system 100 according to an embodiment of the present invention. The POS/DB system 100 is a campus network comprising a plurality of front-end transaction devices 10, a relay server 20, and back-end account servers 30, 40. The campus network of the POS/DB system 100 can be part of almost any entity, including without limitation an educational institution, correctional facility, entertainment facility, sports facility, business, hospital, healthcare system, or research institute. The campus network of the POS/DB system 100 can be a (“LAN”).

There is no limitation on the number of front-end transaction devices 10 can be implemented into the POS/DB system 100. The exact number of front-end transaction devices 10 for any given POS/DB system will be dictated by the needs of the campus on which the POS/DB system is located. Examples of front-end transaction devices 10 include, without limitation, a cash register, a vending machine, a laundry machine, or a website. In fact, almost any commercial device, piece of equipment, or service offered by the campus can be adapted to qualify as a front-end transaction device 10 through proper hardware installation, providing network connections, and/or programming.

Each transactions device 10 is operably connected to the relay server 20 via a connection line 16 or some other means. The connection line 16 can be any cable or line used in the art to connect (and facilitate communicant between) computers, servers, and/or other network components. The connection line 16 is capable of and used to transmit data signals between the transaction devices 10 and the relay server 20. The connection line 16, can be for example, a coaxial cable, a phone line, an Ethernet cable, a fiber-optic cable, or the like. Most preferably, the connection line 16 is an Ethernet connection. While a hard connection line 16 is exemplified as the means by which the front-end transaction devices 10 are operably connected to the relay server 20, those skilled in the art will appreciate that the transaction devices 10 and the relay server 20 can easily be adapted for short-distance or long-distance wireless communication and data transfer through the proper installation of infra-red (“IR”), radio frequency (“RF”), or cellular transmitters and receivers.

The connection line 16 can be used to transmitted data between the relay server 20 and the transaction devices 10 via web services if desired. In such an embodiment, the connection line 16 will preferably be an Ethernet cable and the web services will preferably utilize a port 80 standard.

The relay server 20 is operable connected to each of the back-end account servers 30, 40 via connection lines 26. As with the connection line 16, the connection lines 26 can be any cable or line used in the art to connect (and facilitate communicant between) computers, servers, and/or other network components. The connection lines 26 are capable of and used to transmit data signals between the relay server 20 and the back-end account servers 30, 40. The connection lines 26, can be for example, a coaxial cable, a phone line, an Ethernet cable, a fiber-optic cable, or the like. Most preferably, the connection lines 26 are Ethernet connection lines. While hard connection lines 26 are exemplified as the means by which the relay server 20 is operably connected to the back-end account servers 30, 40, those skilled in the art will appreciate that the relay server 20 and the back-end account servers 30, 40 can easily be adapted for short-distance or long-distance wireless communication and data transfer through the proper installation of infra-red (“IR”), radio frequency (“RF”), or cellular transmitters and receivers.

The data format by which the transaction devices 10 communicate is a modified XML format based on standards established by the Association for Retail Technology Standards (“ARTS”). The invention, however, is not so limited and the transaction devices 10 can communicate using any number of existing, or later developed, data formats/standards. In some embodiments of the invention, a modified XML format is preferred because the standards provided by ARTS may not explicitly support some of the transactions, such as declining balance and cash equivalency. As a result, custom transactions were designed which mimicked those utilized by the ARTS Standards.

The back-end account servers 30, 40 are standard servers, such as ARAMARK'S ScanPlus server. Each back-end account server 30, 40 stores account information for a multitude of user accounts. The back-end account servers 30, 40 are programmed with the proper computer code to perform all necessary account management functions, such as, for example, updating, analyzing, comparing, associating, verifying, encrypting, decrypting, etc. Each of the back-end account servers 30, 40 has a separate IP address or other identifier so that user requests coming from the transaction devices 10 can be matched with the proper account server 30, 40 on which that user's account is stored. The back-end account server 30 communicates using the TCP/IP protocol data format while the back-end account server 40 communicates using the XML data format.

The relay server 20 is a standard server which is properly programmed to carry out the function/processing requirements discussed below, such as data format conversion, transaction logging, decryption, and encryption, etc. One suitable server type that can be used as the relay server 20 is a Microsoft Windows based server, such MS Windows 2003. The relay server 20 provides a bridge between the front-end transaction devices 10 and the back-end account servers 30, 40. The relay server 20 is responsible for communicating with the back-end account servers 30, 40 utilizing whatever application program interface (“API”) that is utilized by the back-end account servers 30, 40. The relay server 20 acts essentially as a universal translator. The relay server 20 communicates to the back-end account servers 30, 40 utilizing web services, TCP sockets, or other similar communication mechanisms.

The relay server 20 is preferably a stand-alone server. The relay server 20 will preferably either sit on or near the account servers 30, 40. For security, the relay server 20 can also be located behind the campus network's firewall.

A single relay server 20 can be programmed to convert the XML data format of the transaction devices 10 into a variety of different data formats. Such a situation may be necessary if the POS/Db system of a campus has multiple back-end account servers that utilize different data formats for communication. There is no limitation on the number of data format conversions that a single relay server 20 can be perform.

The relay server 20 provides is programmed to provide several key benefits. The relay server 20 provides write once capability (i.e., a transaction device 10 developer only needs to build a single interface to the relay server 20. This eliminates the need to develop a separate interface for the many account management applications (i.e., the different data formats) that are available.

The relay server 20 is further programmed so as to utilize a very modem method to interface with the transaction devices 10, implementing benefits such as: (1) security, namely triple DES encryption; (2) XML (or XML modified) data format communication based on retail industry standards; and (3) the ability to utilize web services which provide for high and easy availability in the internet environment.

The relay server 20 can be programmed to communicate with account servers, and facilitate communication between the transaction devices and account servers, that communicate using various older communications protocols. The relay server 20 provides a robust method of communicating to each of the account servers 20. Finally, in some embodiments, the relay server 20 can be programmed to have transaction logging capabilities, which aids in debugging any issues.

All of the relay server's 20 functional capabilities are facilitated through the use of installed software, properly programmed microprocessors, and additional computer hardware as necessary, such as RAM, ROM, EEPROM, BUS, etc.

Finally, the relay server 20 (or another component of the campus network) can be programmed and/or adapted to facilitate communication with an outside system, such as, for example, a gift card or loyalty system.

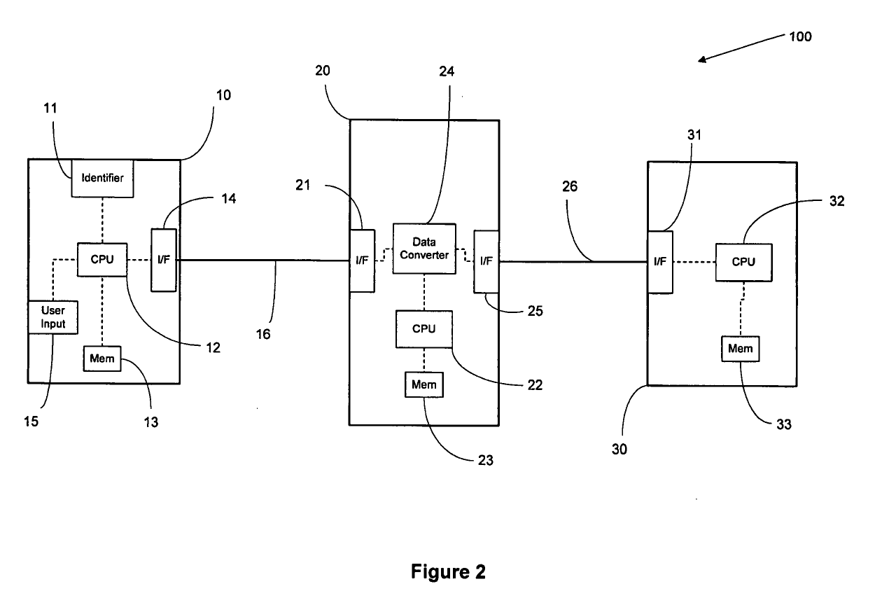

FIG. 2 is a block schematic of the POS/DB system 100 showing basic internal components of the transaction device 10, relay server 20, and account servers 30, 40. For simplicity, only the account server 30 is shown in FIG. 2 with the understanding that the functional relation ship with the account server 40 is similar. Additionally, only a single transaction device 10 is illustrated with the understanding that any number of transaction devices can be utilized in the POS/DB system 100.

The transaction device 10 comprises an identification device 11, a CPU 12, a user input device 15, computer memory 13, and a network communication interface 14. All of the components 11-15 of transaction device 10 are electrically and operably connected. The identification device 11 can be, without limitation, a smart card reader, a pin code entry pad, a magnetic card swipe, a bar code reader, a keyboard, touch pad, or any other device capable of verifying and/or identifying the user account which is subject to the transaction.

The CPU 12 is suitably programmed microprocessor, such as an Intel microprocessor, AMD microprocessor, or any other acceptable microprocessor. The computer memory 13 is connected to the CPU 12 and stores all of the necessary software, computer code, and commands necessary to operate the transaction device, including without limitation the computer code necessary to facilitate encryption/decryption if desired. The CPU 12 can retrieve and execute commands from the memory 12 as necessary. Examples of memory devices 32 include standard hard drive hardware.

The user input device 15 can be, without limitation, a keyboard, a mouse, a touch pad, a button, a lever, or any other device, electrical or mechanical, capable of being manipulated to register a specific user request to be carried out by the transaction device 10. The user input device 15 is coupled to the CPU 12 so that registered user requests can be analyzed by the CPU 12 and the appropriate action taken.

The network communication interface 14 is coupled to the CPU 12 so that as the CPU generates data signals, the network communication interface 14 can receive the signals and further transmit the signals to another network device, such as the relay server 20. The network communication interface 14 can be, without limitation, a USB port, TCP port, an Ethernet port, or any other type of jack or interface connector. Because a modified XML data format is used to communicate between the transaction device 10 and the relay server 20, the network communication interface 14 is preferably an Ethernet cable port.

One end of the connection line 16 is in operable cooperation with the network communication interface 14 of the relay server 20. The other end of the connection line 16 is in operable cooperation with the network communication interface 21 of the relay server. Thus, the relay server 20 is operably connected to the transaction device 10.

The relay server 20 comprises network communication interfaces 21, 25, CPU 22, computer memory 23, and data converter 24. The data converter 24 is located between the network communication interfaces 21, 25 of the relay server 20 and is in operable connection with the CPU 22. The CPU 22 is suitably programmed microprocessor such as an Intel microprocessor, AMD microprocessor, or any other acceptable microprocessor. The computer memory 23 is connected to the CPU 22 and stores all of the necessary software, computer code, and commands necessary to operate the relay server 20, including computer code necessary to facilitate encryption/decryption, conversion of data formats, and transaction logging/recording. The CPU 22 can retrieve and execute commands from the memory 23 as necessary. Examples of suitable memory devices 23 include, without limitation, standard hard drive hardware. Most importantly, the CPU 22 monitor incoming signals and, through the data converter 24, converts the incoming signals into the necessary data format for transmission to the next device. This will be discussed in greater detail below.

As mentioned above, the network communication interface 21 operably connects the relay server 20 to the transaction device 10. Similarly, the network communication interface 25 operably connects the relay server 20 to the account servers(s) 30. The network communication interfaces 21, 25 are coupled to the data converter 24 (and the CPU 22 indirectly) so that as the CPU 22 can convert the formats of data signals and further transmit the signals to another network device. The network communication interfaces 21, 25 can be, without limitation, a USB port, TCP port, an Ethernet port, or any other type of jack or interface connector. Because a modified XML data format is used to communicate between the transaction device 10 and the relay server 20, the network communication interface 21 is preferably an Ethernet cable port. Moreover, the network communication interface 21 preferably utilizes a port 80 standard. On the other hand, the network communication interface 25 is preferably a TCP socket port.

One end of the connection line 26 is in operable cooperation with the network communication interface 25 of the relay server 20. The other end of the connection line 26 is in operable cooperation with the network communication interface 31 of the account server 30. Thus, the relay server 20 is operably connected to the account server 30.

The account server 30 comprises a the network communication interface 31, a CPU 32, and a memory 33. The components 31-33 of the account server 30 are operable coupled and function similar to the corresponding components of the relay server 20 and the transaction device as discussed above.

The computer memory 33 is connected to the CPU 32 and stores all of the necessary software, computer code, and commands necessary to operate the account server 20, including computer code necessary to facilitate encryption/decryption, communication, user account management functions, etc. The CPU 32 can retrieve and execute commands from the memory 33 as necessary. Examples of suitable memory devices 33 include, without limitation, standard hard drive hardware. Most importantly, the memory 33 stores account information for a multitude of user accounts associated with the POS/DB system. The memory 33 also stores all of the commands necessary to update the account information stored thereon (via the CPU 32).

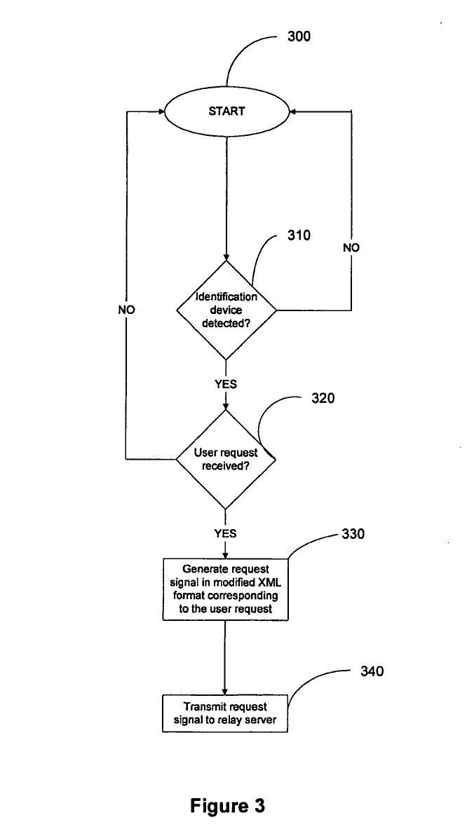

The method of carrying out a cashless transaction utilizing the POS/Db system 100 according to an embodiment of the present invention will be discussed in relation to FIGS. 3-7. For ease of understanding, the method will be discussed in relation to the hardware of FIG. 2 with the understanding that other hardware/network configuration can be used. The method discussed below is not in any way limited to the system shown in FIG. 2.

Referring now to FIG. 3, a high level flowchart of the decision process undertaken by the transaction device 10 in receiving a request from a user having an account stored on the POS/DB system is mapped. The process starts at 300. At decision block 310, the CPU 12 is in a standby mode until an identification device is detected. As discussed above, the identification device can be a smart card reader, a pin code entry pad, a magnetic card swipe, a bar code reader, a keyboard, touch pad, or any other device capable of verifying and/or identifying the user account which is subject to the transaction. If the answer at block 310 is NO, the CPU (and transaction device 10) remains in standby mode.

However, if a user properly presents their identification device to the identifier 11 of the transaction device 10 that is associated with an account stored on the back-end account server 30, the answer at block 310 is YES. Depending on the type of identification used, this may be accomplished by entering a valid pin code into a keypad, swiping a smart or magnetic strip card through a reader, etc.

The CPU 12 then proceeds to 320, at which time the CPU 12 waits for the user to make a register a transaction request via the user input. If a user request is not entered, the CPU 12 cancels the transaction and returns to start block 300. If the user registers a transaction request via the user input 15, the answer is YES and the CPU 12 proceeds to process step 330. In some embodiments of the invention, the user request may be registered by simply presenting the identification device to identifier 11. In such embodiments, decision blocks 310 and 320 will be merged.

The POS/DB system 100 of the present invention can be used to carry out an endless variety of transaction requests/types, including without limitation: (1) Inquiry—an inquiry transaction is done to query the account server to determine the available funds balance of a user/patron on that system; (2) Declining/Inclining Balance—a transaction which will request the removal of finds from a patron account on the account server, the transaction sends a card number and dollar amount, and then expects to get a response back acknowledging that those funds have been removed; (3) Cash Equivalency—for example, the account server in many university environments are often meal based, and as an example, you can receive 3 meals per day. Sometimes there is an equivalent amount allocated for these meals that allows the meal to be exchanged for a dollar value at a location outside of the normal dining hall. The equivalency transaction removes a meal, and returns a dollar amount for the system to utilize. (4) Transaction Detail—This transaction is designed to capture all relevant data from a POS transaction device. This transaction format provides the capability to return detailed item data including SKU, discounts, etc . . . , tender information, and summary transaction information. All transaction types can be provided in real-time as transactions happen, or in a batch mode.

At process step 330, the CPU 12, in response to the user request, generates a transaction request signal corresponding to the user request. The request signal is in the modified XML format and contains all of the pertinent information necessary to carry out the requested transaction, such as price, account identification, etc. An example of an inquiry transaction in the modified XML format to a ScanPlus POS system is set forth below. Note that encryption is not enabled for this example.

```
<POSLOG>
  <Account>DEVICE_1</Account>
  <Transaction>
      <BeginDateTimeStamp>2004-04-14T10:13:45.0000000-
      04:00</BeginDateTimeStamp>
      <EndDateTimeStamp>2004-04-14T10:13:45.0000000-
      04:00</EndDateTimeStamp>
      <OperatorID>1</OperatorID>
      <TransactionTypeCode>INQUIRY</TransactionTypeCode>
      <TransactionID>00001</TransactionID>
      <RevenueCenterID>9999</RevenueCenterID>
        <OffLine>False</OffLine>
    <Inquiry>
      <CustomerID>000000001</CustomerID>
    </Inquiry>
  </Transaction>
</POSLOG>
```

Once the request signal via the instruction of the CPU 12, the request signal (in the modified XML format) is transmitted to the relay server by the network interface 14 via connection line 16 in the port 80 standard, thereby completing step 340. All signals and data can be encrypted and decrypted by the various components of the POS/DB system 100 as needed throughout the process.

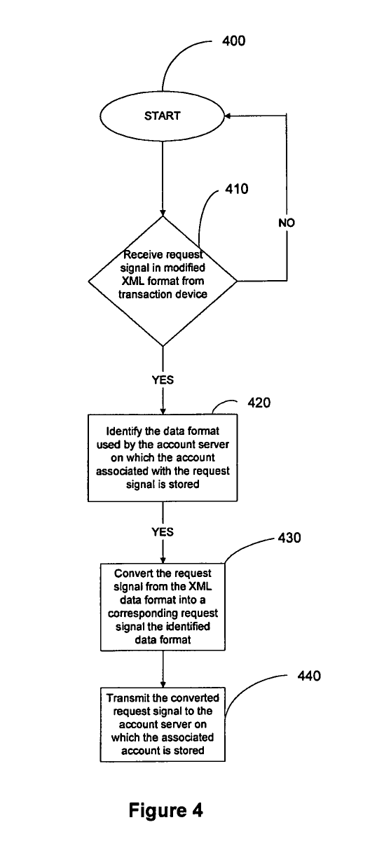

Turning now to FIG. 4, a high level flowchart of the decision process undertaken by the relay server 20 in converting a request signal in the modified XML format into the data format used by the account server 30 is mapped. At the start block 400 and decision block 410, the relay server 20 is in a standby mode awaiting to receive data for translating.

Upon the request signal transmitted by the relay server 20 at step 340 reaching the network communication interface 21 of the relay server 20, the CPU 22 detects the request signal and the answer to decision block 410 is YES. Upon the request signal being detected, the CPU 22, based on the data stored (and possibly encrypted) in the request signal, identifies the data format used by the account server 30 on which the account associated with the request signal is stored, thereby completing process step 420. In embodiments of the invention where a single account server 30 is used in the POS/DB system 100, step 420 may be omitted.

Once the correct data format for communication with the account server 30 is identified, the CPU 22, through its interaction with and control of data converter 24, converts the request signal from the modified XML data format into a data format that can be understood by whatever API the account server 30 is using, thereby completing step 430. The APIs can include proprietary specialized code. The instructions for converting the request signal from the modified XML format to the data format that can be understood by the API of the account server 30 is stored in the memory device 23 as computer code/software. An example of the computer code for converting a request from the XML format into a proprietary data format suitable for communication with the API run on systems, such as ScanPlus is set forth below:

```
Private Function ScanPlus_Inquiry(ByVal AccountName As String, ByVal CardNumber
As String, ByVal Offline As Boolean, ByVal POSTrans_Date As Date) As
CollectiveResult Implements ISocketMediator.ScanPlus_Inquiry
    If Offline Then
            SendString.Append(“O”)
    Else
            SendString.Append(“R”)
    End If
            SendString.Append(“H”)
            SendString.Append(CardNumber.Trim)
            SendString.Append(“*i”)
    If Offline Then
            SendString.Append(Format(POSTrans_Date, “yyMMddHHmm”))
    Else
            SendString.Append(Format(Now, “yyMMddHHmm”))
    End If
            SendString.Append(vbCr)
            SocketInstance = Me.GetSocketInstance(_HostIP, _PortNumber,
AddressFamily.InterNetwork, SocketType.Stream, ProtocolType.Tcp)
    If Not SocketInstance Is Nothing Then
            If Me._CallSynronously = True Then
                Dim SendBytes As Byte( ) =
    ASCII.GetBytes(SendString.ToString)
                SocketInstance.Send(SendBytes, SendBytes.Length, 0)
            Dim RecieveBytes As Int32
    SocketInstance.Receive(RecvBytes, RecvBytes.Length, 0)
        ReceiveString = ASCII.GetString(RecvBytes, 0, RecieveBytes)
            obj.LogEvents(20, _LogDateTimeStamp, “SocketMediator”,
“ScanPlus_Inquiry”, ReceiveString)
            End If
                Dim Outcome As String = ReceiveString.Substring(18, 1).ToLower
        Dim OutcomeCheck As Boolean = (Outcome = “v” Or Outcome = “c”)
            If OutcomeCheck = False Then
                    Me.IsCollectiveResultValid(ReceiveString, Result)
                    Else
                    If Me.IsCollectiveResultValid(ReceiveString, Result)
    Then
                    Result.Balance =
    FormatNumber(CType(ReceiveString.Substring(19, 7).Trim, Decimal) / 100, 2,
TriState.True, TriState.False, TriState.True)
            Result.ClientFirstName = ReceiveString.Substring(41, 15).Trim
            Result.ClientLastName = ReceiveString.Substring(26, 15).Trim
            Result.PatronNumber = ReceiveString.Substring(56, 9).Trim
            Result.CardNumber = ReceiveString.Substring(65, 21).Trim
            Result.IssueNumber = ReceiveString.Substring(ReceiveString.Length − 4,
2).Trim
            Result.Status = Result.Status
            Result.ResponseMessage = Result.ResponseMessage & Result.Balance
            Result.ErrorMsg = ReceiveString.Substring(0, 16).Trim
            Result.Tax_Value = ReceiveString.Substring(17, 1).Trim
        If Result.Status = ReturnStatus.CreditBalance Then
        If (CType(Result.Balance, Decimal) = 0) Then
            Result.ResponseMessage = “Customer Balance is $” & Result.Balance
            Result.Status = ReturnStatus.Valid
            Else
              Result.Balance = “-” & Result.Balance
              End If
              End If
            End If
          End If
          Return Result
      End If
      End Function
```

Once the request signal is properly converted as discussed above, the CPU 22 transmits the converted request signal to the account server via network interface 25 and connection line 26, thereby completing step 440.

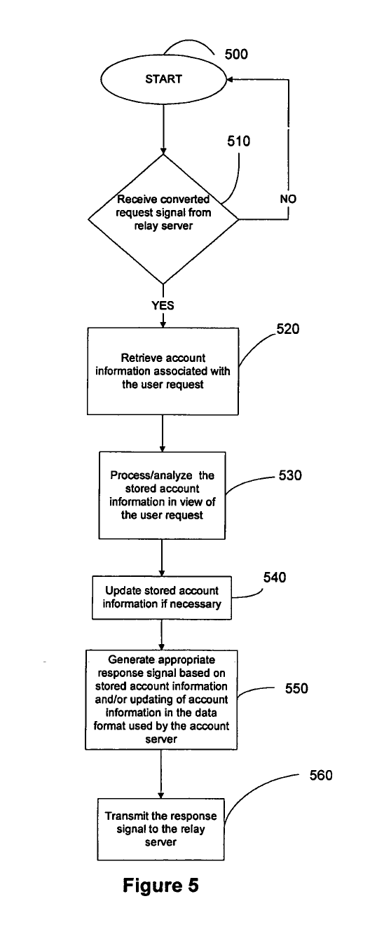

Turning now to FIG. 5, a high level flowchart of the decision process undertaken by the account server 30 in processing a converted request signal is mapped. At the start block 500 and decision block 510, the account server 30 is in a standby mode awaiting to receive converted request signals.

Upon the account server receiving the converted request signal transmitted by the relay server 20 in step 440, the account server receives the converted request signal via network interface 31, resulting in the answer at decision block 510 to be YES. The CPU 32 then proceeds to process block 520 where the CPU 32 retrieves from the memory 33 the stored account information associated with the identified account. Once the account information is retrieved, the CPU 32 will process and analyze the stored account information in view of the parameters of the user request, thereby completing step 530. The processing/analyzing performed at step 530 will depend on the nature of the request registered by the user at the transaction device 10. For example, if the request is a purchase, the CPU 32 will ensure that the account has adequate funds and that no other limitations imposed on the account are compromised. If the account ahs adequate funds, the CPU 32 will approve the request, and update the account information by declining the remaining balance on the account, thereby completing step 540. However, if the request is a mere balance inquiry, updating of the account information may not be necessary.

Depending on the outcome of the processing of the converted request signal in view f the stored account information, the CPU 32 will generate an appropriate response signal, thereby completing step 550. Naturally, the response signal will be in the data format that can be understood by the API of the account server 30. The response signal will contain all of the information necessary to instruct the transaction device 10, such as approval of the transaction requested, updated account information, and/or other pertinent data. Once created, the response signal, which is in the data format that can be understood by the API of the account server 30, is transmitted back to the relay server 20 via connection line 26, thereby completing step 560.

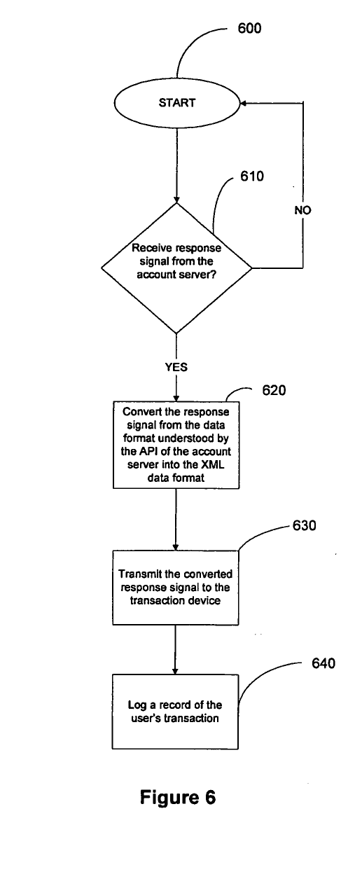

Turning now to FIG. 6, a high level flowchart of the decision process undertaken by the relay server 20 in converting a response signal that is in the data format that can be understood by the API of the account server 30 into the modified XML format is mapped. At the start block 600 and decision block 610, the relay server 20 is in a standby mode awaiting to receive data for translating.

Upon the response signal transmitted by the account server 30 at step 560 reaching the network communication interface 25 of the relay server 20, the CPU 22 detects the response signal in the data format understood by the API of the account server 30 and the answer at decision block 410 is YES. The CPU 22, through its interaction with and control of data converter 24, proceeds to step 620 and converts the response signal from the data format of the API of the account server 30 to the modified XML data format. The instructions for converting the response signal are stored in the memory device 23 as computer code/software.

Once the response signal is properly converted as discussed above, the CPU 22 transmits the converted request signal to the transaction device 10 via network interface 21 and connection line 16, thereby completing step 630. At this time, the relay server 20 then logs a record of the transaction in the memory 23, thereby completing step 640.

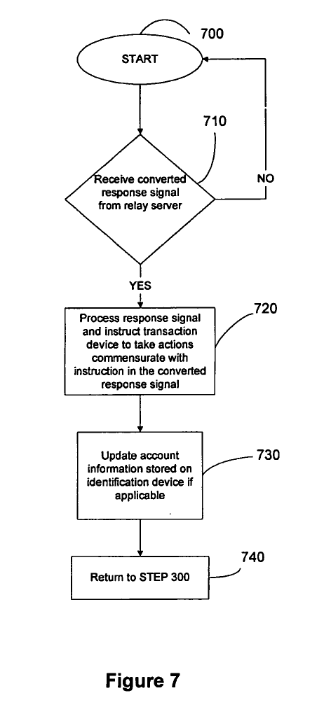

Referring lastly to FIG. 7, a high level flowchart of the decision process undertaken by the transaction device 10 in processing a converted response signal is mapped. At the start block 700 and decision block 710, the transaction device 10 is in a standby mode awaiting to receive a converted response signal from the relay server 20. Upon the converted response signal transmitted by the relay server 20 at step 630 reaching the network communication interface 15 of the transaction device 10, the CPU 12 detects the converted response signal in and the answer at decision block 610 is YES. An example of an inquiry response in the Xml format from a ScanPlus POS System is shown below. Note that encryption is not enabled for this example.

```
<POSResponse>
    <Transaction>
        <DateTimeStamp>2004-04-14T10:13:45.0000000-
        04:00</DateTimeStamp>
        <TransactionTypeCode>INQUIRY</TransactionTypeCode>
        <Status>Valid</Status>
        <StatusCode>0</StatusCode>
        <ResponseMessage>Customer Balance is
        500.00</ResponseMessage>
        <ResponseText />
        <Customer>
          <CustomerID>11111111</CustomerID>
          <CustomerIssueID>01</CustomerIssueID>
          <FirstName>First</FirstName>
          <LastName>Name</LastName>
          <Amount>500.00</Amount>
            <Tax>
            <Tax>
              <TaxAuthority>1</TaxAuthority>
                <UseTax>TRUE</UseTax>
              </Tax>
            </Tax>
      </Customer>
    </Transaction>
</POSResponse>
```

Upon receiving a converted response signal, the CPU 12 proceed to step 720 and processes the response signal. Upon the converted response signal being processed, the CPU 12 will instruct the various components of the transaction device 10 to carry out the instructions/command set fort in the response signal. For example, if the transaction was approved by the account server 30, the CPU 12 may activate a mechanical apparatus, thereby dispensing an item, allowing a turnstile to pass, displaying information, or activating the transaction device 10. The exact actions carried will be dictated on case-by-case basis depending on the identity of the transaction device and the request made by the user. In some embodiments of the invention wherein the identification device used has read/write capabilities, the CPU 12 may update the account information stored on the identification device via identifier device 11.

As a final note, one important feature of the relay server 20 is its ability to translate the various transactional responses from different account servers into a common response set to be returned to the calling transaction devices. This is critical to isolate the transaction device from the complexities of various back-end account servers.

While the invention has been described and illustrated in sufficient detail that those skilled in this art can readily make and use it, various alternatives, modifications, and improvements should become readily apparent without departing from the spirit and scope of the invention.

What is claimed is:

1. A point-of-sale and declining balance (“POS/DB”) system for use in a campus environment comprising:
a campus network comprising at least one transaction device that communicates in a first data format, a relay server operably connected to the transaction device, and an account server operably connected to the relay server that communicates in a second data format, the account server comprising a computer memory medium storing account information; and
wherein the relay server comprises means for converting data signals in the first data format into corresponding data signals in the second data format, and vice versa, to facilitate communication between the transaction device and the account server.

2. The POS/DB system of claim 1 wherein the campus network is a local area network (“LAN”).

3. The POS/DB system of claim 1 wherein the campus network is part of an educational institution, correctional facility, entertainment facility, sports facility, business, hospital, healthcare system, or research institute.

4. The POS/DB system of claim 1 wherein the first data format is extensible markup language (“XML”).

5. The POS/DB system of claim 1 wherein the first data format is a modified XML format based on standards established by the Association for Retail Technology Standards (“ARTS”).

6. The POS/DB system of claim 1 wherein data signals in the first data format are transmitted between the relay server and the transaction device via web services.

7. The POS/DB system of claim 6 wherein the web services utilize a port 80 standard.

8. The POS/DB system of claim 1 wherein the relay server is a stand-alone server.

9. The POS/DB system of claim 1 wherein the relay server either sits on or near the account management server.

10. The POS/DB system of claim 1 further comprising a second account server that communicates in a third data format, the relay server further comprising means for converting data signals in the first data format into corresponding data signals in the third data format, and vice versa, to facilitate communication between the transaction device and the second account server.

11. The POS/DB system of claim 1 wherein data signals in the second data format are transmitted between the relay server and the account server via web services or transmission control protocol (“TCP”) sockets.

12. The POS/DB system of claim 1 wherein the transaction device is a cash register, a vending machine, a laundry machine, or a website.

13. The POS/DB system of claim 1 wherein the relay server is located behind the campus network's firewall.

14. The POS/DB system of claim 1 wherein the campus network further comprises means to encrypt data signals.

15. The POS/DB system of claim 12 wherein the encryption means uses a triple data encryption standard (“DES”).

16. The POS/DB system of claim 1 wherein the relay server further comprises means to log transactions conducted between the transaction device and the account server.

17. The POS/DB system of claim 1 wherein the campus network further comprises means to communicate information to an exterior system.

18. The POS/DB system of claim 1 further comprising:
an identification device associated with a user account stored on the account server;
wherein the transaction device comprises means for validating the identification device, means for receiving a user request associated with the user account upon the identification device being validated, and means for converting said user request into a request signal in the first data format upon a user request being received, and means for transmitting the request signal to the relay server;
wherein the relay server further comprises means for receiving the request signal in the first data format from the transaction device, means for converting the request signal to the second data format upon receiving the request signal; and means for transmitting the converted request signal to the account server;
wherein the account server comprises, means for receiving the converted request signal from the relay server, means for processing the converted request signal upon receipt of the converted request signal, means to update the user account information stored on the computer memory medium if necessary, and means to create a response signal in the second data format as a result of the processing of the converted request signal and/or updating of the user account information.

19. The POS/DB system of claim 18:
wherein the account server further comprises means for transmitting the response signal to the relay server upon the response signal being created;
wherein the relay server further comprises means for receiving the response signal from the account server, means for converting the response signal to the first data format upon receiving the response signal; and means for transmitting the converted response signal to the transaction device; and
wherein the transaction device further comprises means for receiving the response signal from the relay server, and means for executing the response signal.

20. The POS/DB system of claim 19 wherein the transaction device further comprises means for updating the associated account information on the identification device if necessary.

21. The POS/DB system of claim 18 wherein the identification device is selected from a group consisting of a smart card, a magnetic strip card, or a pin code.

22. A point-of-sale and declining balance (“POS/DB”) system for use in a campus environment comprising:
an identification device associated with a user account;
at least one transaction device for reading said identification device and receiving requests associated with said user account, the transaction device communicating via a first data format;
an account server having a computer memory medium storing information pertaining to the user account, the account server communicating via a second data format; and
a relay server operably connected to the transaction device and the account manager server, the relay server comprising a converter for converting the first data format into the second data format and vice versa to facilitate communication between the transaction device and the account server.

23. The POS/DB system of claim 22 wherein the transaction device, the account server, and the relay server are part of a campus network.

24. The POS/DB system of claim 23 wherein the campus network is part of an educational institution, correctional facility, entertainment facility, sports facility, business, hospital, healthcare system, or research institute.

25. The POS/DB system of claim 24 further:
wherein the transaction device is adapted to validate the identification device, receive a user request associated with the user account, generate a request signal in the first data format, and transmit the request signal to the relay server;
wherein the relay server is adapted to receive the request signal from the transaction device, convert the request signal into the second data format, and transmit the converted request signal to the account server; and
wherein the account manager is adapted to receive the converted request signal, process the converted request signal, update the account information stored on the computer memory medium if necessary, generate a response signal in the second data format, and transmit the response signal to the relay server.

26. The POS/DB system of claim 25 further:
wherein the relay server is adapted to receive the response signal, convert the response signal into the first data format, and transmit the converted response signal to the transaction device; and
wherein the transaction device is adapted to receive the converted response signal, execute the converted response signal, and update the account information stored on the identification device if necessary.

27. The POS/DB system of claim 26 further comprising:
means to encrypt data signals;
wherein the first data format is a modified XML format based on standards established by the Association for Retail Technology Standards (“ARTS”);
wherein the relay server either sits on or near the account management server;
wherein the relay server further comprising means for converting data signals in the first data format into corresponding data signals in a third data format, and vice versa, to facilitate communication between the transaction device and a third account server;
wherein the transaction device is a cash register, a vending machine, a laundry machine, or a website; and
wherein the relay server is located behind a firewall.

28. A method of performing a cashless transaction on a point-of-sale and declining balance (“POS/DB”) system in a campus environment comprising:
(a) providing a campus system comprising at least one transaction device, the transaction device communicating in a first data format, an account management server storing user account information, the account server communicating via a second data format, and a relay server operably connected to the transaction device and the account server;
(b) upon the transaction server receiving a request associated with an account stored on the account server, generating a request signal in the first data format with the transaction device;
(c) transmitting the request signal to the relay server;
(d) upon the relay server receiving the request signal, converting the request signal to the second data format;
(e) transmitting the converted request signal to the account server;
(f) upon the account server receiving the converted request signal, processing the converted request signal and, if necessary, updating the account information;
(g) the account server generating a response signal in the second data format and transmitting the response signal to the relay server;
(h) upon the relay server receiving the response signal, the relay server converting the response signal into the first data format and transmitting the converted response signal to the transaction device; and
(i) upon the transaction device receiving the converted response signal, the transaction device either completing or denying the user request.
